(19) United States
(12) Patent Application Publication
(10) Pub. No.: US 2005/0027669 A1
(43) Pub. Date: Feb. 3, 2005

(54) Methods, system and program product for providing automated sender status in a messaging session

(75) Inventors: Don Rutledge Day, Austin, TX (US); Robert J. Kamper, Round Rock, TX (US); Larry Don Swofford, Georgetown, TX (US)

Correspondence Address: BRACEWELL & PATTERSON, L.L.P., P.O. BOX 969, AUSTIN, TX, 78767-0969, US

(73) Assignee: International Business Machines Corporation

(21) Appl. No.: 10/631,059

(22) Filed: Jul. 31, 2003

(51) Int. Cl. G06F 7/00

(52) U.S. Cl. 707/1

(57) ABSTRACT

A process for managing an instant messaging or chat room session provides an automated real-time status of the activity of a participant currently disengaged from the messaging session. Throughout the messaging session, the status a participant is continuously determined, and a status indicator indicating the current action of the participant is sent to the other participant. The instant messaging application, other system applications and all interconnected hardware are monitored for user activity. Detected user activity is interpreted into a status indicator, which is transmitted to the other participant and displayed on the recipient's computer in a preferred format.

### CROSS REFERENCE TO RELATED APPLICATIONS

The present application is related to U.S. patent application Ser. No. 10/______ (AUS920030437US1) which is assigned to the assignee of the present invention and is incorporated herein by reference, in its entirety.

### TECHNICAL FIELD

This invention relates in general to management of messaging sessions, and more particularly relates to management of participant information within a messaging session.

### BACKGROUND

Messaging using various desktop and mobile messaging-enabled digital devices over networks has become commonplace. Messaging methods are varied and include voice messaging and various forms of electronic messaging such as paging, email, fax, instant message exchange, short message services (“SMS”), voice over internet protocol, conference, and chat. Recently, instant message exchange has become very popular. A number of companies offer various solutions for instant message exchange over networks such as the Internet, including Yahoo! Inc., America Online, Inc., and Microsoft Corporation. Typically, these solutions facilitate the exchange of instant messages between the user of a client personal computer system and message recipients, which are commonly referred to by such terms as “pals,” “buddies,” “friends,” “contacts” or “strangers.” These message recipients may be people or machines such as servers. Message recipients may also be a group of people or robots. Instant messages are exchanged essentially instantaneously, or in “real time,” superseding the pace of many other messaging techniques.

Many of the well-known solutions for instant message exchange over the Internet are based on a client-server model. The clients are personal computers (“PCs”), personal digital assistants (“PDAs”), phones and browsers (including Microsoft(R) Internet Explorer and Netscape(R) Navigator). The applications running on these clients are implemented in a variety of software languages and with a variety of protocols, including the wireless access protocol (“WAP”), short message service (“SMS”), hypertext markup language (“HTML”), JavaScript, Java applets, Brew script, J2ME script, and C, C++, or XML code sections. Many instant message exchange solutions work in conjunction with a server based host application over the Internet network or wireless networks to carry out instant message exchange. The server component manages message traffic, delivery, and reporting, while the client component displays an instant message exchange window to show the received message. Alternatively, some solutions, especially those for advanced types of communications devices, do not require a server based instant messaging host application for communications once a connection is made, and may use peer-to-peer communications instead. These solutions typically are implemented with a pre-installed or downloaded client application on, for example, a personal computer, which manages message traffic, delivery, and reporting.

Various distribution techniques for the various solutions are also well known. Client applications, including applications that support peer-to-peer messaging as well as browser plug-ins, may be pre-installed or in firmware, or made available in software form from computer-readable media, such as software loaded from storage media, including magnetic storage media such as diskette, tape and fixed disk, semiconductor storage media such as various types of flash memory cards, and optical storage media such as CD-ROM and DVD-ROM, and software downloaded from distribution media such as networks, including wired and wireless networks, local and wide-area networks, and the Internet. Scripts and short code segments furnished to general purpose browsers typically are downloaded from a network.

A typical feature of the various instant message exchange solutions is keeping track of and visually indicating whether the user's authorized message recipients are online or offline. Instant messages may be sent to and received from any of the user's message recipients who are online. Other typical features include management of the various message recipients, including the grouping of individual message recipients, the addition and deletion of message recipients, and the setting of privacy options; multiparty real time chats with message recipients; and file exchange with message recipients. Some solutions alert the user when particular message recipients come online, provide for voice chat or even multiparty voice conference calls, offer instant message archiving, and permit sending instant messages to offline message recipients. Some solutions provide an electronic whiteboard which allows the user to draw images and type notes to share with others.

Unfortunately, while instant messaging and chat room interfaces offer the advantage of real-time text communication, these systems present significant limitations to effective communication. For example, computer-mediated text communications lack the dramaturgical presence such as voice tone, inflection, timing, and other visual non-verbal queues that permit people to adjust to and handle multiple interrupts and threads during communications. These communication difficulties are further exaggerated by delays in messages resulting from network failures, asynchronized call-and-response threads, participants exiting from a chat room, the time required to compose each new message, and other breaks in communications. For example, the delay that occurs while a message sender is composing a new message might result in the message recipient unintentionally interrupting the sender during composition. Also, the interruption of a sender by another computer application or system will cause an unexplained interruption in the communication with the message recipient within the messaging session.

These inherent pauses in the communication thread of real-time text communication systems creates miscommunication, misqueues, and other problems that can create inefficient or ineffective communication. What is needed is a method and system of managing messaging sessions that addresses some of the above problems to provide improved messaging session communication.

### SUMMARY OF THE INVENTION

In accordance with the present invention, a method, system and program product for providing automated sender status in a messaging session is provided. A data processing system for managing a messaging session performs the steps of determining a participant has disengaged activity in the messaging session; determining a current activity of the participant; and transmitting a status indication to another participant in the messaging session that indicates the current activity of the participant.

In preferred embodiments, the status indication is a textual message to the message recipient, the status indication is a graphic presented to the message recipient, and the message recipient specifies how the status indication is presented to the message recipient. In an alternative embodiment, the step of determining a current activity of the participant comprises determining a current activity of the participant with a hardware system component of the data processing system. In another alternative embodiment, the step of determining a current activity of the participant comprises determining a current activity of the participant with a software system component of the data processing system.

### BRIEF DESCRIPTION OF THE DRAWINGS

FIG. 1 shows a high-level block diagram of a data processing system consistent with an embodiment of the invention with which the method, system and program of the present invention may advantageously be utilized.

FIG. 2 depicts a simplified block diagram of a client/server environment in which electronic messaging typically takes place, in accordance with a preferred embodiment.

FIG. 3 shows an example of a user interface window within an instant messaging program that permits the user to enter preferences for display and transmission settings, in accordance with a preferred embodiment.

FIG. 4 shows a flow diagram of the process for automated sender status by the instant messaging program in a messaging session, in accordance with a preferred embodiment of the present invention.

FIG. 5 shows a screenshot of the message recipient's instant messaging window during a messaging session, in accordance with a preferred embodiment.

### DETAILED DESCRIPTION OF PREFERRED EMBODIMENTS

A preferred embodiment of the present invention is directed to software tools and associated methods of managing instant messaging executing within a data processing system to provide an automated real-time status of the sender's message composition within the messaging session. These software tools and associated methods are embodied within a data processing system, the system software, or a user application such as an instant messenger or chat room application to provide the automated sender status.

In a preferred embodiment of the present invention, a process for managing an instant messaging or chat room session provides an automated real-time status of the activity of a participant currently disengaged from the messaging session. Throughout the messaging session, the status a participant is continuously determined, and a status indicator indicating the current action of the participant is sent to the other participant. The instant messaging application, other system applications and all interconnected hardware are monitored for user activity. Detected user activity is interpreted into a status indicator, which is transmitted to the other participant. For example, if the user engages a telephone system during the messaging session, a status indicator is sent to the message recipient in the session indicating that the user is currently on the telephone. The status indicator is displayed on the recipient's computer in a preferred format. For example, a textual status indicator such as “typing” or a graphic such as a keyboard icon is displayed for the message recipient to convey when the user is currently typing a message in the messaging session. This status indicator would change as the sender typed or paused.

Hardware Overview

The present invention may be executed in a variety of systems, including a variety of computing systems and electronic devices under a number of different operating systems. In one embodiment of the present invention, the messaging system is a portable computing system such as a notebook computer, a palmtop computer, a personal digital assistant, a telephone or other electronic computing system that may also incorporate communications features that provide for telephony, enhanced telephony, messaging and information services. However, the messaging system may also be, for example, a desktop computer, a network computer, a midrange computer, a server system or a mainframe computer. Therefore, in general, the present invention is preferably executed in a computer system that performs computing tasks such as manipulating data in storage that is accessible to the computer system. In addition, the computer system preferably includes at least one output device and at least one input device.

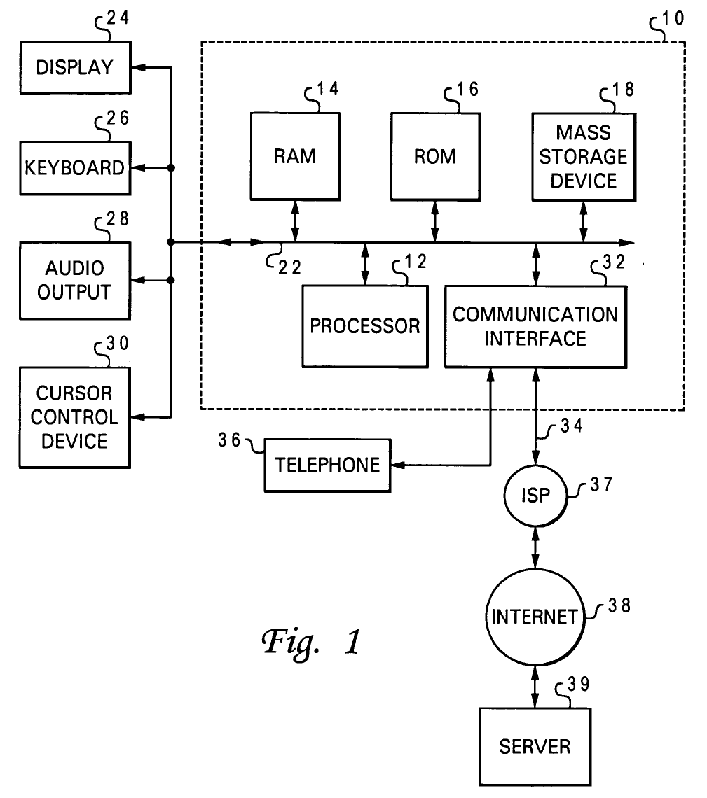

Referring now to the drawings, wherein like numbers denote like parts throughout the several views, FIG. 1 shows a high-level block diagram of a data processing system 10, which may be a high-level computer system, consistent with an embodiment of the invention with which the method, system and program of the present invention may advantageously be utilized. A computer system can be considered as three major components: (1) the application programs, such as a spreadsheet or word processing or graphics presentation application, which are used by the user; (2) the operating system that transparently manages the application's interactions with other applications and the computer hardware; and (3) the computer hardware comprising the processor, the random access memories, the actual electronic components which manage the digital bits. The operating system has a kernel which, inter alia, controls the execution of applications, processes, and/or objects by allowing their creation, termination or suspension, and communication; schedules processes/objects of the same or different applications on the hardware, allocates memory for those objects, administers free space, controls access and retrieves programs and data for the user.

Data processing system or computer system 10 comprises a bus 22 or other communication device for communicating information within computer system 10, and at least one processing device such as processor 12, coupled to bus 22 for processing information. While a single CPU is shown in FIG. 1, it should be understood that computer systems having multiple CPUs could be used. Bus 22 preferably includes low-latency and high-latency paths that are connected by bridges and controlled within computer system 10 by multiple bus controllers.

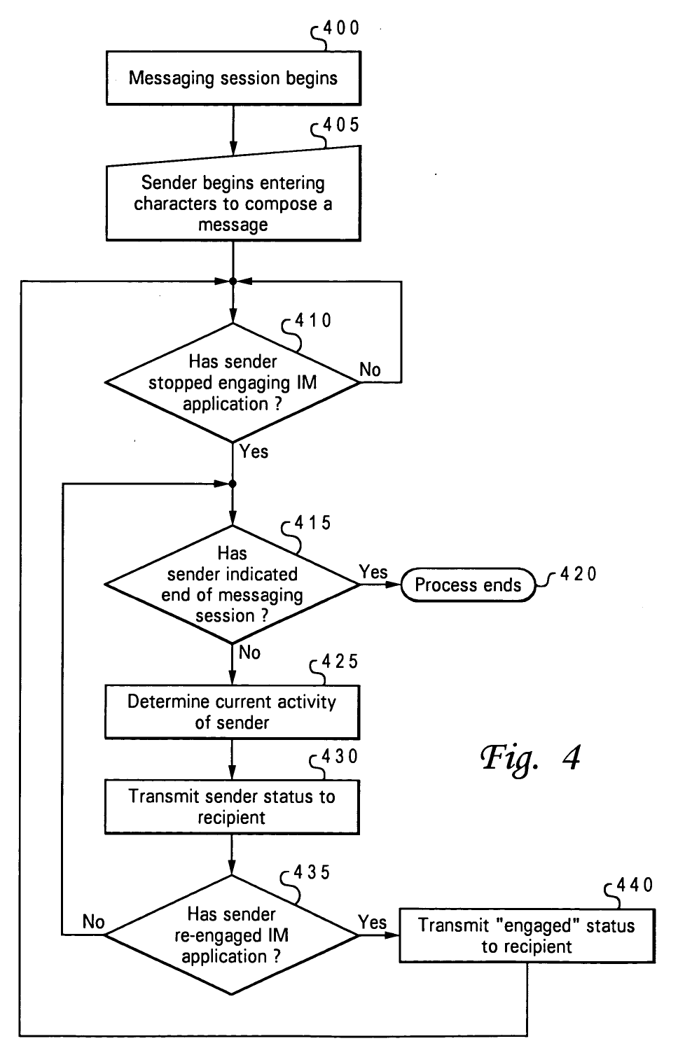

Processor 12 may be a general-purpose processor such as IBM's PowerPC.™ processor that, during normal operation, processes data under the control of operating system and application software stored in a dynamic storage device such as random access memory (RAM) 14 and a static storage device such as Read Only Memory (ROM) 16 and mass storage device 18, all for storing data and programs. The system memory components are shown conceptually as single monolithic entities, but it is well known that system memory is often arranged in a hierarchy of caches and other memory devices. The operating system preferably provides a graphical user interface (GUI) to the user. In a preferred embodiment, application software contains machine executable instructions that when executed on processor 12 carry out the operations depicted in the flowchart of FIG. 4 and others described herein. Alternatively, the steps of the present invention might be performed by specific hardware components that contain hardwire logic for performing the steps, or by any combination of programmed computer components and custom hardware components.

Communication bus 22 supports transfer of data, commands and other information between different devices within computer system 10; while shown in simplified form as a single bus, it may be structured as multiple buses, and may be arranged in a hierarchical form. Further, multiple peripheral components may be attached to computer system 10 via communication bus 22. For example, an audio output 28 is attached to bus 22 for controlling audio output through a speaker or other audio projection device. A display 24 such as a cathode-ray tube display, a flat panel display, or a touch panel is also attached to bus 22 for providing visual, tactile or other graphical representation formats. A keyboard 26 and cursor control device 30, such as a mouse, trackball, or cursor direction keys, are coupled to bus 22 as interfaces for user inputs to computer system 10. In alternate embodiments of the present invention, additional input and output peripheral components may be added. Communication bus 22 may connect a wide variety of other devices (not shown) to computer system 10 and to other adapters connected to other devices such as, but not limited to, audio and visual equipment, tape drives, optical drives, printers, disk controllers, other bus adapters, PCI adapters, workstations using one or more protocols including, but not limited to, Token Ring, Gigabyte Ethernet, Ethernet, Fibre Channel, SSA, Fiber Channel Arbitrated Loop (FCAL), Ultra3 SCSI, Infiniband, FDDI, ATM, ESCON, wireless relays, USB, Twinax, LAN connections, WAN connections, high performance graphics, etc., as is known in the art.

Communication interface 32 provides a physical interface to a network, such as the Internet 38. This interface may comprise a modem connected to a telephone line 34 through which an Internet access provider (ISP) 37 or online service provider is reached, but increasingly other higher bandwidth interfaces are implemented. For example, data processing or computer system 10 may be connected to another network server via a local area network using an Ethernet, Token Ring, or other protocol, the second network server in turn being connected to the Internet. Alternatively, communication interface 32 may be provided communication through cable television, fiber optics, satellites, wireless, or other connections. Communication interface 32 has capability to communicate with communications systems, such as integrated services digital network (ISDN), public telephone switched network (PTSN), or asynchronous digital subscriber line (ADSL), and with telecommunication systems such as telephone 36 independently coupled to the PTSN. Internet 38 may refer to the worldwide collection of networks and gateways that use a particular protocol, such as Transmission Control Protocol (TCP) and Internet Protocol (IP), to communicate with one another. ISP 37 and Internet 38 both use electrical, electromagnetic, or optical signals that carry digital data streams. The signals through the various networks and the signals on network link 34 and through communication interface 32, which carry the digital data to and from computer system 10, are exemplary forms of carrier waves transporting the information. The representation of FIG. 1 is intended as an exemplary simplified representation of a high-end computer system, it being understood that in other data processing systems 10, variations in system configuration are possible in addition to those mentioned here.

Finally, data processing system 10 need not be a computer at all. Data processing system 10 may be a simpler appliance-like client device, also called an embedded device, having less processing power and memory such as a network terminal, a thin client, a terminal-like device, a voice response unit, etc. Data processing system 10 may be a mobile architecture such as laptops, sub-notebooks, and handheld computers such as personal digital assistants and companion devices, or a mobile device such as smartphones, pagers, simple messaging devices and wearable devices. Thus, when the data processing system 10 is a mobile or an embedded device, a variety of multi-modal interfaces are supported including traditional keyboard and mouse interfaces, small text screens, pen, touch screens, speech recognition, text-to-speech and other emerging technologies like wearable devices. Such special-purpose devices for accessing the world wide web, such as an Internet access box for a television set, or a portable wireless web accessing device, which can implement an adapter for the purpose of communicating data to/from another computer system are also intended to be within the scope of a data processing system 10. As will be described in detail below, aspects of the preferred embodiment pertain to a specific method or process having steps implementable on a data processing system 10.

The present invention may be provided as a computer program product, included on a machine-readable medium having stored thereon the machine executable instructions used to program computer system 10 and/or to a peripheral device for installation on a connected adapter to perform a process according to the present invention. The term “machine-readable medium” as used herein includes any medium, signal-bearing media or computer readable storage media that participates in providing instructions to processor 12 or other components of computer system 10 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patters of holes, a programmable ROM (PROM), an erasable PROM (EPROM), electrically EPROM (EEPROM), a flash memory, any other memory chip or cartridge, or any other medium from which computer system 10 can read and which is suitable for storing instructions. In the present embodiment, an example of nonvolatile media is storage device 18. Volatile media includes dynamic memory such as RAM 14. Transmission media includes coaxial cables, copper wire or fiber optics, including the wires that comprise bus 22. Transmission media can also take the form of electromagnetic, acoustic or light waves, such as those generated during radio wave or infrared wireless data communications. Thus, the programs defining the functions of the preferred embodiment can be delivered to the data processing system 10 information on any machine-readable medium, which include, but are not limited to: (a) information permanently stored on non-write storage media, e.g., read only memory devices within either computer such as CD-ROM disks readable by CD-ROM; (b) alterable information stored on write-able storage media, e.g., floppy disks within a diskette drive or a hard-disk drive; or (c) information conveyed to a computer by a telephone or a cable media network, including wireless communications. Such signal-bearing media, when carrying instructions that may be read by an adapter or a computer to direct the functions of the present invention, represent alternative embodiments.

Messaging Systems Context

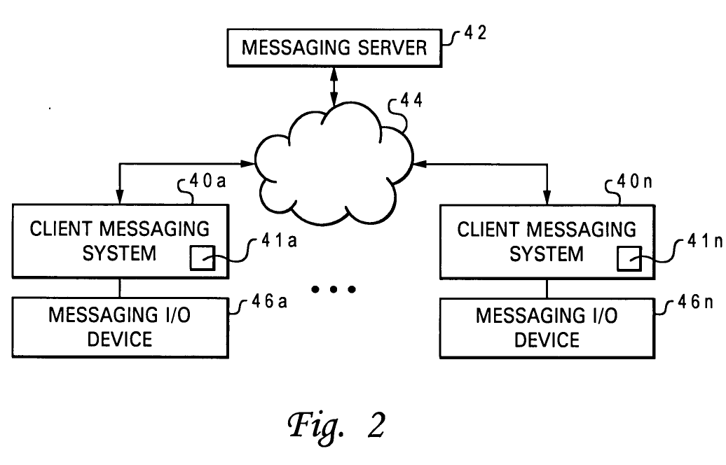

With reference now to FIG. 2, there is depicted a simplified block diagram of a client/server environment in which electronic messaging typically takes place in accordance with the method, system and program of the present invention. In a preferred embodiment, a client enters a message via one of messaging input/output (I/O) devices 46a-46n for a messaging session at a client messaging system such as client messaging system 40a. The message entry is transmitted to messaging server 42. Messaging server 42 then distributes the message entry to the users participating in the messaging session via network 44. The client/server environment is implemented within multiple network architectures. For example, the architecture of the World Wide Web (the Web) follows a traditional client/server modeled environment.

The terms “client” and “server” are used to refer to a computer's general role as a requester of data (the client) or provider of data (the server). Further, the terms “sender” and “recipient” are used to refer to a computer's general role as a sender of a message during a messaging session (the message sender) or as a receiver of a message during a messaging session (the recipient). In the Web environment, web browsers such as Netscape Navigator typically reside on client messaging systems 40a-40n and render Web documents (pages) served by at least one messaging server such as messaging server 42. Additionally, each of client messaging systems 40a-40n and messaging server 42 may function as both a “client” and a “server” and may be implemented utilizing a computer system such as computer system 10 of FIG. 1. Further, each of client messaging systems 40a-40n may function as both a “sender” and a “recipient” and typically act as both during a typical messaging session. Still further, while the present invention is described with emphasis upon client messaging systems 40a-40n engaged in peer-to-peer network communications via a network 44, the present invention may also be performed by messaging server 42 controlling a messaging session. Furthermore, other types of messaging systems may be utilized to implement the present invention, as will be understood by one skilled in the art.

The Web may refer to the total set of interlinked hypertext documents residing on servers all around the world. Network 44, such as the Internet, provides an infrastructure for transmitting these hypertext documents between client messaging systems 40a-40n and messaging server 42. Documents (pages) on the Web may be written in multiple languages, such as Hypertext Markup Language (HTML) or Extensible Markup Language (XML), and identified by Uniform Resource Indicators (URIs) that specify the particular messaging server 42 and pathname by which a file can be accessed, and then transmitted from messaging server 42 to an end user utilizing a protocol such as Hypertext Transfer Protocol (HTTP). Web pages may further include text, graphic images, movie files, and sounds as well as Java applets and other small-embedded software programs that execute when the user activates them by clicking on a link.

Advantageously, according to one embodiment of the present invention, the steps of the present invention and other functions may be performed by an application executing in each of client messaging systems 40a-40n, such as client managing applications 41a-41n. Further, client messaging systems 40a-40n may include or receive information from client messaging systems 40a-40n, communication devices, personal storage devices, global positioning systems, and other devices that provide personal information about a user that client managing applications 41a-41n may provide to messaging server 42. For example, where personal exercise information is received, client managing applications 41a-41n may determine that a user is exercising while communicating via one of client messaging systems 40a-40n. Further, advantageously, a client messaging system may access more than one messaging server 42 at the same time where each messaging server 42 represents an independent messaging system with independent user interfaces and protocols.

Messaging System Processes

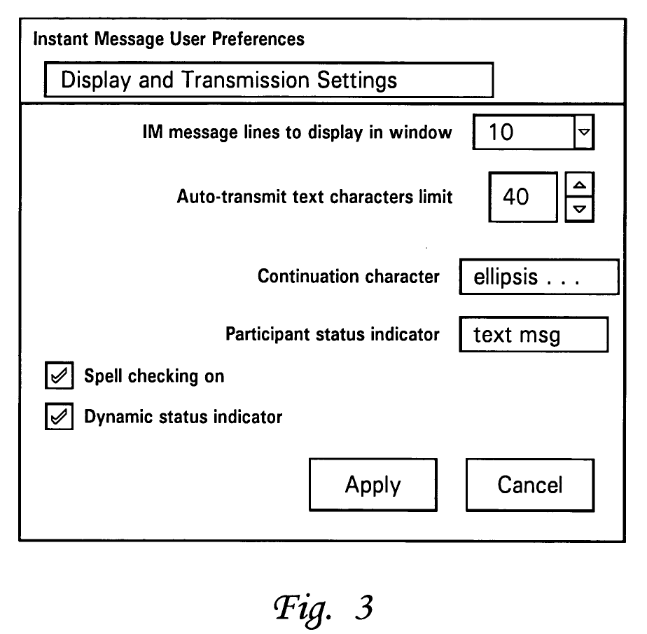

FIG. 3 shows an example of a user interface window within an instant messaging program that permits the user to enter preferences for display and transmission settings, in accordance with the preferred embodiment. FIG. 4 shows a flow diagram of the process for providing automated sender status in a messaging session by the instant messaging program, in accordance with the preferred embodiment of the present invention. The process begins when a messaging session is initiated by an instant messaging application, as shown at step 400. At step 405, the sender begins typing a message into a message window to compose the instant message. At step 410, it is determined if the sender has stopped engaging the instant messaging (IM) application. This would be determined by detecting keyboard or mouse activity in a window within the instant messaging application. For example, if the user is typing on keyboard 26, processor 12 would detect this activity on bus 22 and determine what application is receiving the input keys. Also, an internal timer could be reset within the instant messaging application each time the user enters a character or other user command, with a specified time limit indicating the user is no longer engaged with the application. If the determination at step 410 is that the user has disengaged from the IM application, the process proceeds to step 415, where it is determined if the sender has indicated the end of its participation in the messaging session. If so, the process ends as shown at step 420. If not, the process proceeds to step 425, where the current activity of the message sender is determined by the computer system 10.

In a preferred embodiment, processor 12 in FIG. 1 determines what processes are currently being executed in the computer system 10 and are being actively interfaced by the user over bus 22. For example, if the user is typing on keyboard 26, processor 12 would detect this activity on bus 22 and determine what application is receiving the input keys. Further, computer system 10 is coupled to other hardware devices such as telephone 36 and server 39, either or both of which may be currently engaged by the user. For example, the user may be currently engaged in a telephone call on telephone 36 and is unable to participate in the current messaging session. In another example, the user may be currently typing on keyboard 26 into an e-mail form operating in an e-mail application operating on system 10. Computer system 10 detects such user activity on the coupled hardware device to determine that the sender is currently active on that device.

Referring back to FIG. 4, the determined current activity of the user is translated into a “status indication” at step 425, which is transmitted to the recipient at step 430. The translation into user's status is determined based on the user preferences set by the user, for example in the “Display Transmission Settings” window shown in FIG. 3 provided in the instant messaging session. For example, as seen in FIG. 3, a participant's status indicator has been set to “text MSG,” signifying that the participant status indicator should be displayed to the recipient as a text message. Alternatively, the user could set the participant status indicator to a different communication form such as audio or graphic. For example, if set to graphic display, a graphic image is displayed on the recipient's message window such as an icon on avatar. In alternative embodiments, the status can be transmitted to the message recipient as a separate file or executable that is utilized or executed on the recipient's instant messaging application or computer system to present the character, image, animation, audio, etc.

In a preferred embodiment, the participant status indicator preference is set by the message sender and specifies the type of indicator reported to the message recipient to provide the message sender status. In an alternative embodiment, the preference for the participant status indicator is set by the message recipient, and the status indicator sent by the message participant is a status code interpreted by the recipient's instant messaging application to present the applicable status in the preferred format for the message recipient.

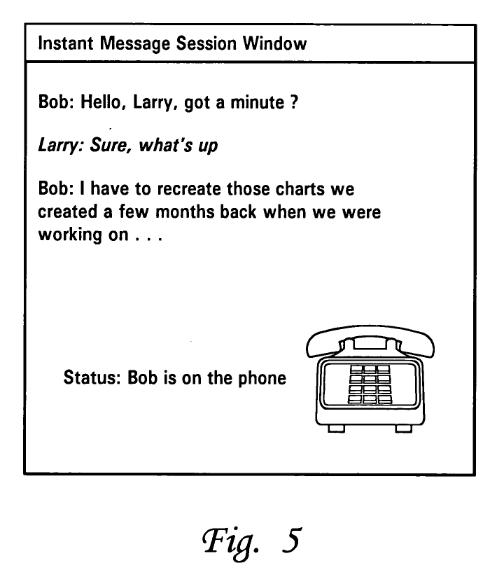

FIG. 5 shows a screenshot of the message recipient's instant messaging window during a messaging session in accordance with the preferred embodiment. The screenshot shows that the message sender (“Bob”) is currently composing a message to the message recipient (“Larry”). It can be seen at the bottom of the instant message session window that a status is presented for the current activity of the other participant in the current messaging session. Here, the status states “Bob is on the phone” and also presents a graphic image of a phone. Thus, in accordance with the preferred embodiment, Bob's computer system 10 detected activity on Bob's telephone 36 and transmitted a participant status indicator to Larry's instant messaging application indicating that Bob was on the phone. Based on either Bob's or Larry's participant status preferences (appropriate contention logic resolved any conflicting preferences) both a text and icon status was presented to the message recipient.

Returning to FIG. 4, after transmission of the participant status indicator, the process proceeds to step 435, where it is determined if the participant has re-engaged the IM application. If the participant has still not re-engaged the IM application, the process returns to step 415 to determine if the user has terminated its participation in the messaging session. If the user has re-engaged the IM application, the process proceeds to step 440, where a special “engaged” or reset status is sent to the recipient to indicate the participant's re-engagement. Upon receipt of the “engaged” status, the recipient instant messaging application would reset or modify the status indicator to indicate that the user is now participating in the messaging session. The displayed status is then be left blank during the messaging session, or alternatively a status message is displayed, such as the current activity of the user within the IM application. For example, the status could indicate that the user is currently typing an instant message to the recipient. Following step 440, the process returns to step 410 to again detect when the user has stopped engaging the IM application.

While the invention has been particularly shown and described with reference to a preferred embodiment, it will be understood by those skilled in the art that various changes in form and detail may be made therein without departing from the spirit and scope of the invention.

1. A method in a data processing system for managing a messaging session, said method comprising the steps of:
determining a participant has disengaged activity in the messaging session;
determining a current activity of the participant; and
transmitting a status indication to another participant in the messaging session that indicates the current activity of the participant.

2. The method according to claim 1, wherein the status indication is a textual message to the message recipient.

3. The method according to claim 1, wherein the status indication is a graphic presented to the message recipient.

4. The method according to claim 1, wherein the message recipient specifies how the status indication is presented to the message recipient.

5. The method according to claim 1, wherein the step of determining a current activity of the participant comprises determining a current activity of the participant with a hardware system component of the data processing system.

6. The method according to claim 1, wherein the step of determining a current activity of the participant comprises determining a current activity of the participant with a software system component of the data processing system.

7. A data processing system for managing telephone numbers contained within a web page in accordance with user preferences, said system comprising:
means for determining a participant has disengaged activity in the messaging session;
determining a current activity of the participant; and
transmitting a status indication to another participant in the messaging session that indicates the current activity of the participant.

8. The data processing system according to claim 7, wherein the status indication is a textual message to the message recipient.

9. The data processing system according to claim 7, wherein the status indication is a graphic presented to the message recipient.

10. The data processing system according to claim 7, wherein the message recipient specifies how the status indication is presented to the message recipient.

11. The data processing system according to claim 7, wherein the step of determining a current activity of the participant comprises determining a current activity of the participant with a hardware system component of the data processing system.

12. The data processing system according to claim 7, wherein the means for determining a current activity of the participant comprises means for determining a current activity of the participant with a software system component of the data processing system.

13. An article of manufacture comprising machine-readable medium including program logic embedded therein that causes control circuitry to perform the steps of:
determining a participant has disengaged activity in the messaging session;
determining a current activity of the participant; and
transmitting a status indication to another participant in the messaging session that indicates the current activity of the participant.

14. The article of manufacture of claim 13, wherein the status indication is a textual message to the message recipient.

15. The article of manufacture of claim 13, wherein the status indication is a graphic presented to the message recipient.

16. The article of manufacture of claim 13, wherein the message recipient specifies how the status indication is presented to the message recipient.

17. The article of manufacture of claim 13, wherein the step of determining a current activity of the participant comprises determining a current activity of the participant with a hardware system component of the data processing system.

18. The article of manufacture of claim 13, wherein the step of determining a current activity of the participant comprises determining a current activity of the participant with a software system component of the data processing system.
